(19) United States
(12) Patent Application Publication
(10) Pub. No.: US 2015/0233701 A1
(43) Pub. Date: Aug. 20, 2015

(54) Enhanced OCT Measurement and Imaging Apparatus and Method

(71) Applicant: Josh HOGAN, (US)

(72) Inventor: Joshua Noel Hogan, Los Altos, CA (US)

(21) Appl. No.: 14/435,701

(22) PCT Filed: Oct. 12, 2013
(86) PCT No.: PCT/US13/64738

§ 371 Date: Apr. 14, 2015

Related U.S. Application Data
(60) Provisional application No. 61/714,159, filed on Oct. 15, 2012.

(51) Int. Cl. G01B 9/02

(52) U.S. Cl. CPC G01B 9/02083; G01B 9/02091; G01B 9/02075

(57) ABSTRACT

The invention teaches a method, apparatus and system for enhancing measurement and imaging using optical coherence tomography (OCT) by using a pressure wave, such as ultrasound, in conjunction with OCT to make measurements and generate images of a target. The pressure signal modulates the refractive index of the target at high speed, thereby disrupting the generation of a constant speckle noise pattern and thereby reducing speckle noise. The pressure signal can also be switched between at least two states at high speed which enables acquiring a high speed differential signal related weak scattering sites thereby enabling enhanced measurement and imaging of targets such as tissue. In the particular case of measurement of the concentration of glucose in tissue, differential signals enhance the accuracy with which the glucose concentration can be measured.

### CROSS REFERENCES TO RELATED APPLICATIONS

This application, docket number CI120925PC claims priority from U.S. provisional application 61/714,159 filed Oct. 15, 2012, and is related to U.S. provisional 61/518,053, docket number CI110429PR, entitled “Optic Characteristic Measuring System and Method”, and U.S. utility application Ser. No. 13/459,168, entitled “Optic Characteristic Measuring System and Method” the entirety of each of which are incorporated by reference as if fully set forth herein.

### FIELD OF THE INVENTION

This invention relates to the field of OCT analysis and analysis systems. In particular the invention relates to improvement in OCT systems by improvement of signal to noise ratios.

### BACKGROUND OF THE INVENTION

Since its inception in the early 1990's, OCT has been widely applied as an analytic tool. The OCT analysis systems developed over the past decades have been applied to many non-invasive imaging and measurement challenges.

OCT systems are more useful when signal to noise ratios are improved. Signal to noise ratios are improved by increasing signal or decreasing noise or by doing both. Problems exist with improving signal to noise ratios. Many approaches have been taken to improving signal to noise.

Non-invasive imaging and analysis is a valuable technique for acquiring information about systems or targets which may be inanimate targets or animate targets. Examples of suitable inanimate targets include: documents, such as currency notes; miniature components, such as plastic parts; seals in packaging, such as food packaging. Animate targets include human tissue, for example for three dimensional fingerprinting purposes or tissue analysis for medical purposes. An advantage of non-invasive imaging and analysis is that it can be performed without undesirable side effects, such as damaging the target or system being analyzed. In the case of analyzing living entities, such as human tissue, undesirable side effects of invasive analysis include the risk of infection along with pain and discomfort associated with the invasive process.

In the particular case of non-invasive in-vivo imaging or analysis of biological tissue or tissue fluids it is desirable to image or measure properties with enhanced accuracy or clarity. A non-invasive method with increased precision enables more accurate monitoring.

Optical coherence tomography also referred to as low coherence reflectometry emerged as a technique for imaging tissue or for measuring properties of tissue. Such techniques are described in patents, such as, U.S. Pat. No. 5,321,501 and papers, such as, “Optical coherence-domain reflectometry: a new optical evaluation technique” by Youngquist et Al. Optics Letters/Vol. 12, No. 3/March 1987 Page 158.

Optical coherence tomography (OCT) is now routinely used for in-vivo imaging of biological components such as tissue. In particular the field of ophthalmology benefits from imaging various regions of the human eye including the anterior region and the retinal region.

For example, OCT can image the iris and cornea region and thereby obtain information that enables measuring the angle between the iris and cornea, through which fluid must flow to escape via the trabecular meshwork. This angle is of relevance in detecting glaucoma. As another example OCT can measure retinal layer thicknesses to detect the onset of age related macular degeneration.

OCT has also been explored as a technique for measuring glucose concentration. For example U.S. Pat. No. 6,725,073 by Motamedi, et al., titled “Methods for noninvasive analyte sensing” describes using OCT to measure glucose concentration. U.S. Pat. No. 7,526,329 by Hogan and Wilson titled “Multiple reference non-invasive analysis system” describes using a variant of time domain OCT to measure glucose concentration.

These approaches exploit a correlation between blood glucose concentration and the scattering coefficient of tissue that has been reported in Optics Letters, Vol. 19, No. 24, Dec. 15, 1994 pages 2062-2064. The sensitivity of an OCT signal to glucose concentration is described in a paper titled “Specificity of noninvasive blood glucose sensing using optical coherence tomography technique: a pilot study”, Phys. Med. Biol. 48 (2003) pp. 1371-1390 by Larin et al.

An alternate approach to measuring glucose concentration using OCT, but involving a sensitivity to different temperatures is described in U.S. Pat. No. 8,078,244 by Melman, et al., titled Interferometric method and instrument for measurement and monitoring blood glucose through measurement of tissue refractive index. However, the speed of this approach is severely limited owing to the rate at which the temperature change can be accomplished, and the problem of target movement can introduce uncertainty and imprecision.

Whether the target of interest is inanimate or animate, all of these uses of OCT can have performance degraded due to a form of optical noise typically referred to by those skilled in the art as speckle noise. This form of optical noise is due to interference between light scattered from adjacent scatterers in a target. Speckle noise reduces the clarity of OCT images and limits the accuracy with which measurements can be made with OCT.

Furthermore in the case of measuring tissue components, such as, for example, glucose, by exploiting a sensitivity of scattering to different temperatures, any requirement for temperature change stabilization limits the speed at which related measurements can be made, making the system vulnerable to motion artifacts.

What is needed is an OCT system and method that reduces optical noise, and speckle noise in particular, thereby enabling differentiation of weak signals from a target of interest. What is also needed is a rapidly executed solution to optical noise, ideally operating at a speed comparable to the OCT scan speed. What is also needed is an improved system for imaging a target under analysis.

There is therefore an unmet need for reducing speckle noise and enhancing OCT measurement and imaging capability and in particular an enhanced method of measuring glucose concentration.

### BRIEF SUMMARY OF THE INVENTION

This invention provides a solution to at least all the above recited unmet needs. The invention provides a method, apparatus and system for enhanced OCT measurement and imaging. Herein, OCT means “optical coherence tomography.” The invention provides using a pressure wave in conjunction with OCT to make measurements and generate images of a target. The pressure signal modulates the refractive index of the target at high speed.

This high speed modulation of the refractive index of the target disrupts the generation of a constant speckle noise pattern and thereby reduces the impact of speckle noise. Reduction of optical noise (speckle) permits enhanced detection of weak signals. The inventive method and system provide improvements in signal to noise ratios, which consequently provides enhancement of weak signals and noise reduction.

The selection of the pressure wave frequency depends on the OCT system selected and the target of interest. For applications where the target of interest is inanimate (ex. a food package seal integrity; a fully embedded 3D manufactured part) the pressure wave may be in the low to moderate frequency range, as the speed of the OCT scan may likewise be low to moderate, generally less than 2 MHz.

For applications where the target of interest is animate, the OCT scan rate may be extremely rapid so as to reduce any motion artifacts (ex. living eye tissue, skin, 3D fingerprinting, glucose concentration, etc.) and the pressure wave selected will likewise be higher frequency, generally more than 2 MHz.

In embodiments of the invention using pressure waves of 2 MHz or greater, the pressure signal can be switched between at least two states. The contribution of the scattering coefficients in components of living tissue differs in the two states. Switching between the two states at high speed produces a high speed differential signal related to the tissue component of interest in the target.

In one embodiment of the invention optimized for living tissue component measurement and analysis, the contribution to the scattering coefficient of tissue due to a tissue component such as, for example, glucose differs in the two states. Switching between the two states at high speed enables acquiring a high speed differential signal related to the concentration of glucose to be detected, thereby enhancing both the specificity of the signal to glucose and the accuracy with which the glucose concentration can be measured.

### BRIEF DESCRIPTION OF THE DRAWINGS

FIG. 1 is an illustration of the analysis system according to the invention.

FIG. 2 is an illustration of examples of the timing relationship between OCT depth scans and frequency aspects of the pressure wave signal.

FIG. 3 is a flow chart depicting the steps in an embodiment suitable for reducing speckle noise according to the invention.

FIG. 4 depicts an alternate embodiment suitable for providing improved sensitivity for measuring weak scattering OCT signals according to the invention.

FIG. 5 is a flow chart depicting the steps of generating an enhanced OCT scan of a target according to an embodiment of the invention.

### DETAILED DESCRIPTION OF A PREFERRED EMBODIMENT OF THE INVENTION

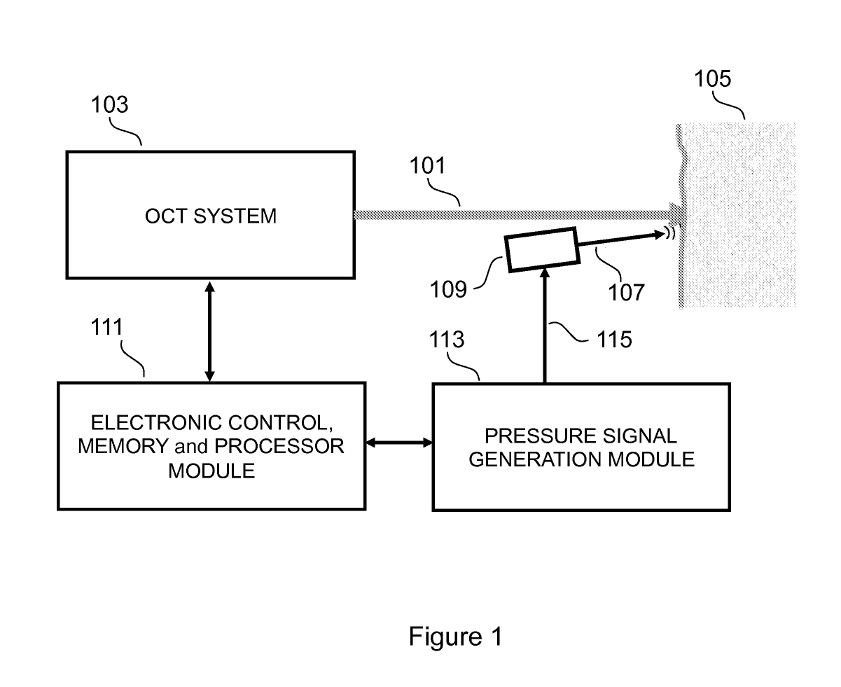

A preferred embodiment of the invention is illustrated in and described with respect to FIG. 1. The probe beam 101 of an OCT system 103 is applied to a target 105. Some of the light that comprises the probe beam is scattered within the target back in the direction of the OCT system 103 where it generates at least one interference signal that provides information from which a scattering depth profile of the target 105.

At the same time the OCT scan occurs, a pressure wave 107 generated by a pressure wave generator 109, is applied to the same region of the target 105 as the OCT system is probing. An electronic control, memory and processor module 111 controls the operation of the OCT system. The module 111 also controls the operation of a pressure signal generation module 113.

The module 111 also includes memory that stores digitized signals generated by the OCT system and a processor that processes the digitized OCT signals in conjunction with information about the pressure wave 107. The pressure drive signal 115 from the pressure signal generation module 113 controls the pressure generator 109.

In the preferred embodiment the OCT system is a time domain OCT (TD-OCT) system, either a conventional time domain OCT system or a multiple reference OCT system which is a variant of a conventional time domain OCT system and is described in U.S. Pat. Nos. 7,486,405 and 7,751,862 both of which are incorporated herein by reference as if fully set forth herein. It must be understood that although the invention is described herein with respect to a conventional TD-OCT system, it is applicable to all forms of OCT.

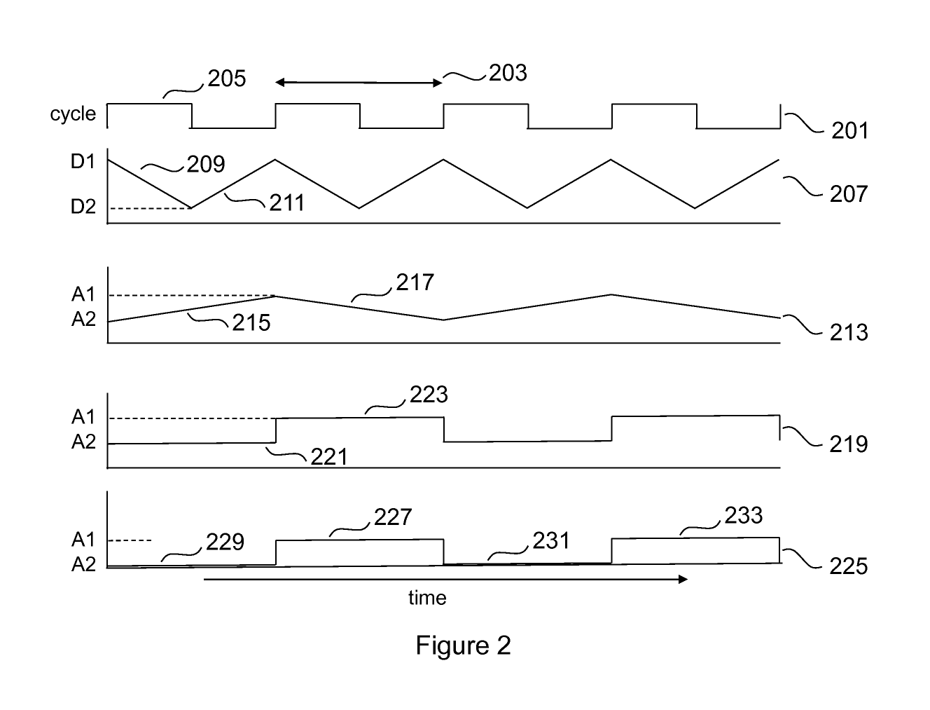

The optimum relationship between the repetitive motion of the reference mirror of a TD-OCT system and the pressure wave depends on characteristics of the target, such as the refractive index of one or more components of the target. A number of possible relationships are illustrated in FIG. 2. Referring now to FIG. 2, where the repetitive motion of the reference mirror is represented by the top trace 201 labeled “cycle”. A single cycle of the repeated cycle is indicated by the double arrow 203. For all traces depicted in FIG. 2, the horizontal axis is the Time axis.

During the first half 205 of a repetitive cycle, a conventional TD-OCT system will scan from a less deep to a deeper region of the target; and during the second half of a repetitive cycle the OCT system scans from the deeper region of the target to the less deep region. This is illustrated in trace 207 [scan depth trace] where the labels D1 and D2 refer to the least deep and the most deep target regions respectively. The trace segments 209 and 211 indicate the depth transitions.

Trace 213 indicates a variation in the pressure wave amplitude between two values labeled A2 and A1. In the preferred embodiment, the transition between A2 and A1 is a linear ramp indicated by 215 and 217. In the preferred embodiment, the linear ramp represents an amplitude or frequency change of the pressure wave and the abrupt transitions between the direction of the linear ramps of the pressure wave signal are synchronized with the repetitive cycle time of the reference mirror.

Although trace 213 depicts abrupt transitions between A1-A2 of the pressure wave amplitude or frequency occurring at each repetitive cycle 203, in alternate embodiments there could be many cycles between abrupt transitions. Indeed, while synchronized transitions are desirable for optimum performance they are not essential. Furthermore in applications where the primary use of the pressure wave is speckle noise reduction, the amplitude or frequency of the pressure wave could be varied in a pseudo random manner.

A pressure wave can be considered as a propagating sequence of compression and rarefication regions that has the effect of modulating the refractive index of components within the target. This modulation of the refractive index of components within the target modifies optical path lengths within the target. Speckle noise is directly related to optical path lengths between scatterers within the target. By modifying optical path lengths between scatterers within the target by use of a pressure or ultrasound wave, speckle noise can be randomized and averaged out.

Furthermore the effect of a pressure wave, such as that depicted in trace 207, on an OCT scan depth trace can be monitored; and the pressure wave drive signal 115 of FIG. 1 can be modified to optimize speckle noise reduction and thereby enhance the imaging and measurement capability of the OCT. For example trace 219 depicts a pressure wave signal switching between two amplitudes or between two frequencies A1 and A2 so that successive scans have different pressure wave environments indicted by levels 221 and 223.

As is known to those skilled in the art, scattering of the probe beam occurs because of a refractive index mismatch between components of a target. The larger the refractive index mismatch at an interface, the larger is the magnitude of scattering at that interface. A significant portion of scatterers that contribute to an OCT image comprise interfaces with refractive index mismatches of significant magnitude.

The small refractive index change generated by a pressure wave has relatively little effect on the magnitude of scattering at such interfaces. Therefore there is relatively little change in successive OCT scans or one dimensional depth images taken at the same location, other than changes in speckle noise.

In the case of interfaces with only a slight refractive index mismatch, the small refractive index change generated by a pressure wave has a relatively large effect on the magnitude of scattering at such weakly scattering interfaces. For example, the interface between interstitial fluid in tissue and other tissue components, such as membranes, has a small refractive index mismatch. Therefore the small refractive index change generated by a pressure wave has a relatively large effect on the magnitude of scattering at these tissue fluid interfaces.

By applying a pressure wave drive signal 115 of FIG. 1 such as that depicted in trace 225 of FIG. 2, the difference between two successive OCT scans taken at the same location is substantially influenced by the change in refractive index mismatch due to different high frequency pressure wave signals. This difference signal is therefore sensitive to interfaces that have a small refractive index mismatch, such as the refractive index mismatch between interstitial fluid in tissue and other tissue components, such as membranes.

In trace 219 the pressure wave segment 223 labeled A1 has an amplitude or a frequency larger in magnitude than the amplitude or frequency of the pressure wave segment 221 labeled A2. The amplitude or frequency magnitudes can be optimized for a specific target. In the case of switching between two different amplitudes, the optimum amplitude magnitude for the weaker signal A2 could be zero for some targets, as depicted in trace 225 where segment 227 has a non-zero amplitude value and segment 229 has a substantially zero amplitude value.

In the case of applying a pressure wave to a target in order to reduce speckle noise the amplitude or frequency of the pressure wave is varied to cause a time varying change in the refractive index of at least some portions of the target. The time varying change in refractive index causes a time varying change in the distance between scatterers in the target and thereby a time varying change in speckle noise which enables speckle noise to be reduced by processing techniques, such as averaging successive OCT scans with different pressure wave environments.

Depending on the manner in which the target is being scanned by the OCT system in the lateral direction (as opposed to the depth scan direction), the frequency of the pressure wave and the speed with which it is varied in time are both selected to optimize averaging to reduce speckle noise.

For example in a case where an OCT system is scanning the same location repeatedly and then moving in the lateral direction to scan an adjacent location of the target, a suitable approach would be to have a constant amplitude and frequency for the duration of one bidirectional depth scan and then switch to a different constant amplitude and frequency for the duration of the following bidirectional depth scan and so forth for the depth scans at a single location.

In a case where scanning in a lateral direction is continuous and therefore is a raster scan, and where the same lateral region is repeatedly scanned, then the approach is to have a constant amplitude and frequency for the duration of one complete lateral scan and then switch to a different constant amplitude and frequency for the duration of the following complete lateral scan and so forth for all the lateral scans at a single region of the target.

In a case where scanning in a lateral direction is continuous and therefore is a raster scan, and where the same lateral region cannot be repeatedly scanned (for reasons such as motion of the target), then the approach is to have a time varying amplitude and/or frequency that varies within the duration of one complete depth scan.

The frequency of the pressure wave is typically higher and preferably significantly higher than the frequency of the time varying signal that modulates the amplitude and/or frequency of the pressure wave.

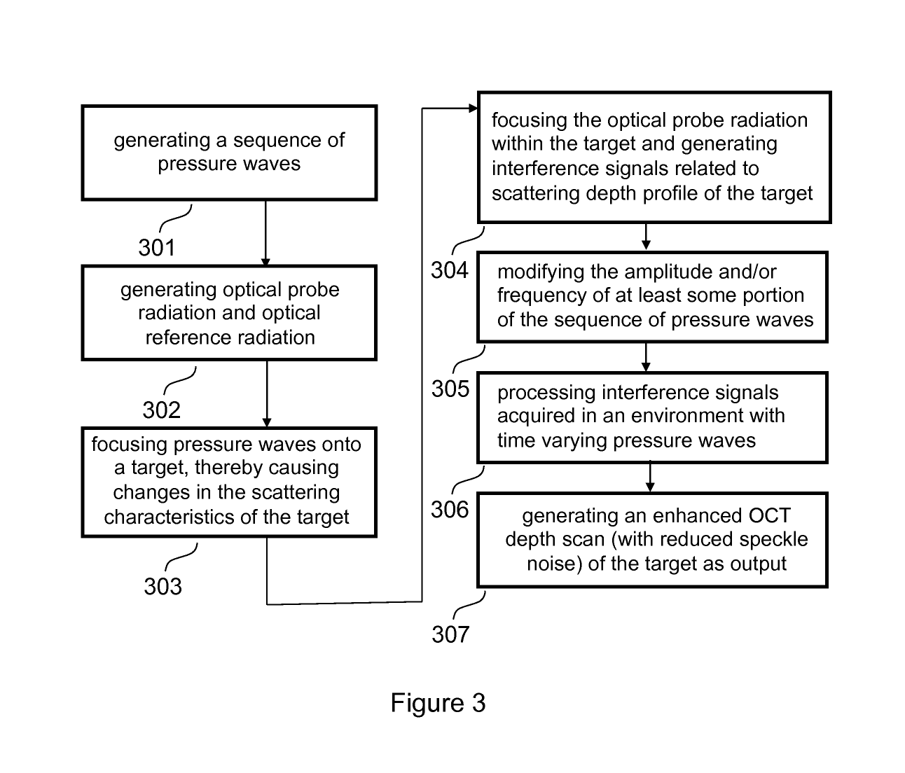

FIG. 3 depicts the method of generating an enhanced OCT scan by reducing speckle noise associated with an OCT scan of a target comprising the steps of:

Step 1, 301, generating a sequence of pressure waves by means of a pressure signal generation module that outputs a pressure drive signal to a pressure wave generator, which generator outputs pressure waves directed at the target.
Step 2, 302, generating optical probe radiation and optical reference radiation.
Step 3, 303, focusing pressure waves onto a target, thereby causing changes in the refractive index and thereby changes in the scattering characteristics of the target.
Step 4, 304, focusing the optical probe radiation of the OCT system within the target and generating interference signals related to a scattering depth profile of the target whereby the OCT system is operable to acquire a depth scan of the target using optical coherence tomography.
Step 5, 305, modifying the amplitude and/or frequency of at least some portion of the sequence of pressure waves by means of an electronic control module that connects the OCT system and the pressure signal generation module, and controls scanning by the OCT system and generation of the pressure waves and wherein the electronic control module is configured to cause the pressure signal generation module to output one or more pressure waves with characteristics selected to locally modify the refractive index of the target in a manner that diversifies the phase relationship between light scattered by adjacent scatterers in the target, thereby reducing speckle noise in said target and improving sensitivity of the OCT system.

Step 6, 306, processing interference signals generated by the interaction of the optical reference radiation and scattered probe radiation in conjunction with the modified pressure waves to generate a sequence of OCT depth scans taken at one or more locations in the target.

Step 7, 307, generating an enhanced OCT scan of the target due to speckle noise reduction caused by modifying the amplitude or frequency of a pressure wave within an OCT depth scan or by averaging OCT scans in conjunction with the modified pressure wave signals that modify the refractive index of at least some components of the target.

In a preferred embodiment of the invention applying a pressure wave to a target while performing an OCT scan provides enhanced sensitivity to weak scattering signals.

The relationship between scattering and the refractive index mismatch is discussed in the Optics Letters reference “Optics Letters, Vol. 19, No. 24, Dec. 15, 1994 pages 2062-2064”. In this reference the Rayleigh-Gans theory is employed as an approximation to Mie theory to find the dependence of the reduced scattering coefficient on the refraction index mismatch. This scattering coefficient is shown therein in equation 1 to be dependent on the square of the refractive index mismatch.

Some relevant text and equation 1 from page 2063 of this reference are paraphrased below. If the two refractive indices at a refractive index transition are n1 and no, then the refractive index mis-match is n₁−n₀. When there is a small refractive index mis-match, that is, when

$$\vert \frac{{n}_{1}}{{n}_{0}} - 1 \vert ≪ 1 ,$$

the reduced scattering coefficient has the following dependence on the indices of refraction

$${μ}_{s}^{′} = {K ( \frac{{n}_{1} - {n}_{0}}{{n}_{0}} )}^{2}$$

where K is a proportionality factor related to particle size, wavelength, and particle density and includes g (the average cosine of the scattering angle).

A consequence of this squared relationship is that a scattering interface with a small refractive index mismatch that is experiencing a periodic sinusoidal modulation of the refractive index has a different scattering amplitude from the same interface experiencing no modulation of the refractive index, or the same interface experiencing a different modulation of the refractive index.

The invention provides a pressure wave generating such a periodic sinusoidal modulation of the refractive index. Furthermore a pressure wave with a high frequency (for example a frequency of 2 MHz or greater) generates a periodic sinusoidal modulation of the refractive index at corresponding high frequency. The effect of this difference in scattering amplitude in the presence or absence of periodic sinusoidal modulation of the refractive index is more significant for weak scattering interfaces where there is a small refractive index mismatch. This is elaborated upon in paragraph 51 hereinbelow. In particular successive depth scans taken at substantially the same location of the target but with different pressure wave environments can be processed to provide a differential signal has enhanced sensitivity to weak scattering sites within the target.

Techniques for generating the differential signal include, but are not limited to, subtracting successive signals where the successive signals have different pressure wave environments from each other. Because the differing pressure wave environments have relatively little effect on the interference signals due to strong scattering sites but have a relatively large effect on the interference signals due to weak scattering sites, the differential signals enable a technique for enhancing weak signals due to components of the target with small refractive index mismatch.

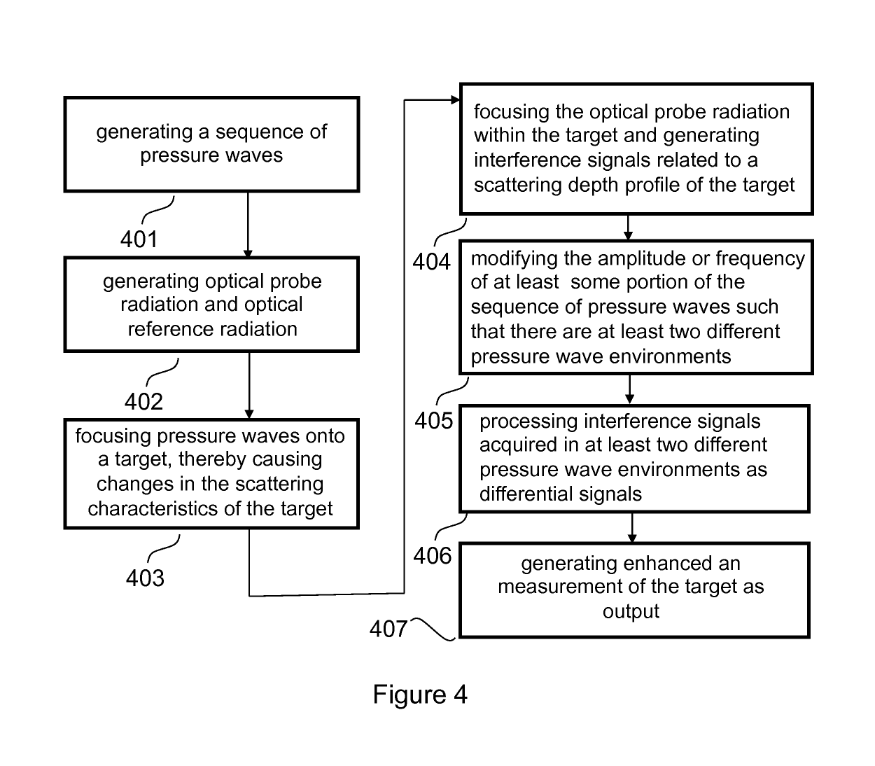

FIG. 4 is a flowchart depicting an embodiment of the inventive method, comprising the steps of:

Step 1, 401, generating a sequence of pressure waves, where the frequency of the pressure wave is selected to optimize refractive index mismatch of target components.
Step 2, 402, generating optical probe radiation and optical reference radiation by means of an OCT system configured to acquire a depth scan of the target using optical coherence tomography.
Step 3, 403, focusing pressure waves onto a target, thereby causing changes in the scattering characteristics of the target, by means of a pressure signal generation module that outputs a pressure drive signal to a pressure wave generator, which outputs pressure waves directed at the target.
Step 4, 404, focusing the optical probe radiation within the target and generating interference signals related to scattering depth profile of the target.
Step 5, 405, modifying the amplitude or frequency of at least some portion of the sequence of pressure waves such that there are at least two different pressure wave environments by an electronic control module that connects the OCT system and the pressure signal generation module, and controls the OCT system and the pressure waves wherein the electronic control module is configured to cause the pressure signal generation module to output one or more pressure waves to generate at least two pressure wave environments within the target whereby in at least one pressure wave environment the refractive index of the target is locally modified in a manner that alters magnitude of light scattered within the target.
Step 6, 406, processing interference signals acquired in at least two different pressure wave environments as differential signals by means of a processing module configured to determine the scattering due to small refractive index mismatches as a differential function of the different scattering characteristics of signals due to light scattered in at least two pressure wave environments thereby measuring weak scattering signals within said target with enhanced sensitivity. Said another way, processing a first depth scan of a first region with a refractive index of n₀ₐ and a second region with a refractive index of n₁ₐ in a first environment a; and in a second environment b, a second depth scan of the first region with a refractive index of n_{0b} and the second region with a refractive index of n_{1b}, determining the reduced scattering coefficients μₛₐ′ and μ_{sb}′ using the scattering characteristics as described in the equation set forth in paragraph [046] and thereby obtaining a differential signal, where the differential signal is the difference between the first and second depth scan. In one embodiment the differential function is the difference between the two scattering characteristics. In one embodiment an enhanced OCT depth scan of said target is acquired that is a sequence of differences between scattering characteristics. Scattering characteristics are scattering coefficients, scattering intensities and any other observed indicator of a change in scattering at a particular site.
Step 7, 407, generating an enhanced measurement of components of a target as output by computing the difference in the depth scattering profile between at least two OCT depth scans taken at substantially the same lateral location in the target, where the two OCT depth scans are acquired while the target is in a different pressure wave environment for each of the two OCT depth scans.

An example of such a measurement would be the thickness of a weakly scattering layer in tissue or the distance between two layers in tissue, at least one of which could be a weakly scattering layer. Tissue contains components that have small refractive index mismatches and therefore contain one or more weak scattering sites. A specific example is the interface between extra cellular fluid (ECF) with a refractive index of ˜1.348 to 1.352 and cellular membranes and protein aggregates with a refractive index of ˜1.350 to 1.460 in human tissue (the target).

Acquiring at least two OCT depth scans taken at substantially the same location in human tissue, where the two OCT depth scans are acquired while the tissue is in a different pressure wave environment for each of the two OCT depth scans enables a more sensitive technique for measuring the scattering coefficient at such weakly scattering interfaces in tissue.

The refractive index of ECF (also referred to as interstitial tissue fluid) has been shown to be more sensitive to the concentration of glucose rather than other analytes typically found in interstitial tissue fluid. Therefore the difference between two successive OCT scans taken at the same location in tissue but with different pressure wave environments is substantially influenced by the concentration of glucose in the interstitial fluid of the target.

An embodiment suitable for measuring glucose concentration in human tissue is now described with reference to FIG. 2. In this embodiment where the target is living tissue and tissue characteristic to be measured or monitored is the concentration of glucose, a suitable amplitude for the pressure wave segment 229 labeled A2 is zero and the pressure wave, segment 227 labeled A1 has an amplitude that minimizes or maximizes the refractive index mismatch between interstitial tissue fluid and other fluid components at one of the two points of maximum amplitude of the periodic pressure wave.

With such a configuration the difference between alternate sets of OCT scans (corresponding to pressure wave scan segments sets 229, 231 and 227, 233, repeated) is substantially dependent on scattering due to weak scattering at interfaces with a small refractive index mismatch and therefore substantially dependent on the glucose concentration of the interstitial fluid, thus enabling an enhanced method of measuring glucose concentration.

The invention provides that measurements other than glucose concentration can be made with enhanced sensitivity using a similar differential technique. For example scattering signals due to layer interfaces in tissue that have a small refractive index mismatch are enhanced. This measurement technique enables enhanced measurement of thickness of tissue layers which has applications in ophthalmology where the thickness of layers such as retinal layers are measured.

This measurement technique also enables enhanced measurement of thickness of skin tissue layers which has applications in biometry. Such applications include but are not limited to, fingerprinting and hydration measurement.

Furthermore, rather than measuring glucose concentration in ECF or interstitial fluid, this technique also enables enhanced measurement of blood glucose concentration by measuring the scattering due to the refractive index mismatch between the refractive index of blood and the refractive index of the wall of a blood vessel.

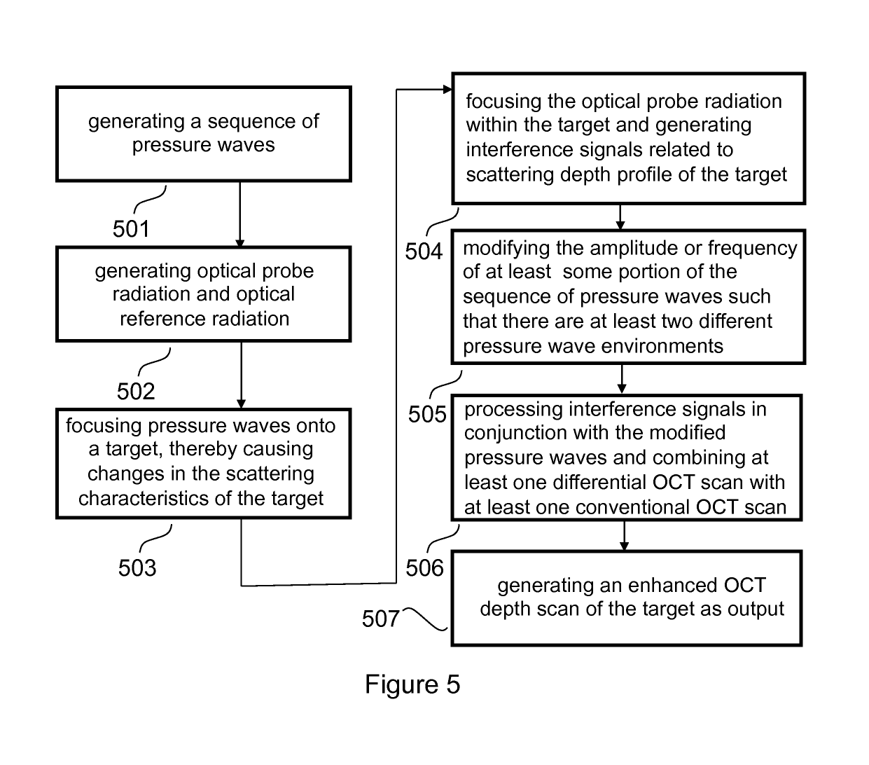

FIG. 5 depicts an embodiment of a method of generating an enhanced OCT scan of a target according to the invention. This embodiment includes acquiring OCT depth scans in at least two different pressure wave environments at substantially the same target location and generating one or more differential OCT depth scans.

At least one of the acquired OCT depth scans is acquired in a pressure wave environment that reduces speckle noise and is referred to herein as a conventional OCT scan or conventional OCT depth scan (as opposed to a differential OCT depth scan). A generated differential OCT depth scan is combined with conventional OCT depth scan where both scans were acquired at substantially the same target location, to generate an enhanced OCT depth scan of the target.

Many approaches can be taken to combine the differential OCT depth scan and the conventional OCT depth scan, including applying a first gamma correction factor to the differential OCT depth scan and a second gamma correction factor to the conventional OCT depth scan and then adding the two gamma corrected scans together to generate an OCT depth scan wherein signals due to weak scattering sites or interfaces are enhanced.

An alternate approach is to combine a set of depth scans that are offset in a lateral direction to form at least one 2D image. In this approach a first image is formed using a set of differential OCT depth scans and a second image of the same target region using a set of conventional OCT depth scans. In this case a first gamma correction factor is applied to the first differential image and a second gamma correction factor is applied to the second image.

The two images are then combined by pixel by pixel addition to form an enhanced image wherein signals due to weak scattering sites or interfaces are enhanced. Such an approach is useful, for example, for generating 2D images of retinal layers some of which have weakly scattering properties.

In FIG. 5 this embodiment that provides an enhanced depth scan of a target is depicted and comprises the steps of:

Step 1, 501, generating a sequence of pressure waves.
Step 2, 502, generating optical probe radiation and optical reference radiation.
Step 3, 503, focusing pressure waves onto a target, thereby causing changes in the scattering characteristics of the target.
Step 4, 504, focusing the optical probe radiation within the target and generating interference signals related to scattering depth profile of the target.
Step 5, 505, modifying the amplitude or frequency of at least some portion of the sequence of pressure waves such that there are at least two different pressure wave environments.
Step 6, 506, processing interference signals generated by the interaction of the optical reference radiation and scattered probe radiation in conjunction with the modified pressure waves to generate a sequence of OCT depth scans taken at at least one location in the target, generating at least one differential OCT scan and combining at least one differential OCT scan with at least one conventional OCT scan.
Step 6, 507, generating an enhanced OCT depth scan of the target as output.
The relationship between the transition between the two pressure wave environments and the timing of the depth scanning mechanism (for example the piezo scanner in the TD-OCT case) could be such as to coincide with alternate bi-directional OCT depth scans or alternatively with alternate lateral scans of the OCT system.

The preferred embodiment is described with respect to a time domain OCT system, however, the invention is applicable to all forms of OCT systems, including conventional time domain and multiple reference time domain, spectral domain and swept source Fourier domain. In the case of swept source Fourier domain OCT the abrupt transitions of the pressure wave amplitude or frequency are synchronized with the repetition rate of the wavelength sweep. In such a case the triangular shape of trace 207 of FIG. 2 could be replaced with a saw-tooth wave form.

The preferred embodiment uses a pressure wave with a frequency typically in the MHz regime—generally at or above 2 MHz—and the particular frequency is selected to be optimal for a particular target. Alternate embodiments use a lower frequency pressure wave. In an alternate embodiment using a multiple reference time domain OCT system, the frequency of the pressure wave is chosen to be the same frequency as the reference mirror displacement device (typically a piezo device).

In some embodiments the pressure wave is generated by the same device as the reference mirror displacement device. In such embodiments the target experiences a compression for the duration of an OCT scan for one direction of the reference mirror displacement device and the target experiences a rarefication for the duration of an OCT scan in the reverse direction.

Many combinations of the invention are possible. For example, in the preferred embodiments speckle noise reduction and glucose concentration measurement are described separately, however, glucose concentration measurement and speckle noise reduction could be combined. This could be accomplished by OCT scanning substantially the same location with different pressure wave environments, where the different pressure wave environments differ by having different non-zero amplitude pressure wave signals, or differ in the frequency of the pressure wave signals, or differ by having both different non-zero amplitude pressure wave signals and have pressure wave signals of different frequencies.

The invention relates to non-invasive optical imaging, measurement and analysis of targets. This specification has presented a selection of applications of the invention, primarily with targets of living tissue. It can be appreciated that targets of interest are nearly unlimited, and include both biological tissue, such as skin; structures or components of an eye, a living eye in particular and non-biological targets, such as, small micro machined parts, including 3D micro machined parts; food packaging seals which can be inspected for their integrity.

With respect to human tissue, the invention includes enhanced monitoring or measuring physical characteristics tissue in general, and of skin or the eye in particular, under controlled conditions so as to image or to monitor for or measure characteristics such as glucose concentration of tissue or tissue fluids, or internal pressure of an eye, or aspects related to a malignant condition or the propensity to develop a malignant condition, such as glaucoma or cancer.

Other examples will be apparent to persons skilled in the art. The scope of this invention should be determined with reference to the specification, the drawings, the appended claims, along with the full scope of equivalents as applied thereto.

1. (canceled)

2. An improved optical coherence tomography system, said system capable of acquiring at least a first depth scan of a target in a first environment, said first depth scan of said target penetrating at least a first region of refractive index n₀ₐ in said first environment and a second region of refractive index n₁ₐ in said first environment, and where
$$\vert \frac{{n}_{1 a}}{{n}_{0 a}} - 1 \vert << 1 ,$$
said improvement comprising:
a pressure signal generation module, said pressure signal generation module outputting a pressure drive signal to a pressure wave generator, which generator outputs pressure waves of at least one preselected frequency,
and where said pressure waves are directed at said target, thereby effecting a second environment and altering the refractive index of said first region to n_{0b} in said second environment and the refractive index of said second region to n_{1b} in said second environment, and where
$$\vert \frac{{n}_{1 b}}{{n}_{0 b}} - 1 \vert ≪ 1 ,$$
and where said system acquires a second depth scan of said target in said second environment;
a processing module that determines the scattering characteristics of said first region and said second region of said target during said first depth scan in said first environment where said scattering characteristics are described by the equation
$${μ}_{sa}^{′} = {K ( \frac{{n}_{1 a} - {n}_{0 a}}{{n}_{0 a}} )}^{2}$$
and the scattering characteristics of said first region and said second region during said second depth scan in said second environment
where said scattering characteristics are described by the equation
$${μ}_{sb}^{′} = {K ( \frac{{n}_{1 b} - {n}_{0 b}}{{n}_{0 b}} )}^{2}$$
where μₛₐ′ and μ_{sb}′ are reduced scattering coefficients, and K is the proportionality factor related to particle size, wavelength and particle density and includes the average cosine of the scattering angle, and
obtaining the differential signal, where said differential signal is the difference between said first and said second depth scan, and which, because of the squared relationship, enables detecting of scattering signals attributable to said first and said second region in said target; and
an electronic module connecting said optical coherence tomography system and said pressure signal generation module, which controls the output of said pressure signal generation module.

3. (canceled)

4. (canceled)

5. The system as in claim 4, wherein said processing module is further configured to generate and output an enhanced optical coherence tomography depth scan of said target by combining a differential optical coherence tomography depth scan and a conventional optical coherence tomography depth scan.

6. The system as in claim 2, wherein said system performs alternate bi-directional scans which scans coincide with said first environment and said second environment.

7. The system as in claim 2, wherein said system performs alternate lateral scans which said scans coincide with said first and said second environments.

8. (canceled)

9. (canceled)

10. (canceled)

11. The system as in claim 2, wherein said pressure wave generator generates at least one preselected frequency above 2 MHz.

12. The system as in claim 2, wherein said pressure wave generator operates at a speed at least ten time greater than the scan speed of said optical coherence tomography system.
